(19) United States
(12) Patent Application Publication
(10) Pub. No.: US 2003/0057655 A1
(43) Pub. Date: Mar. 27, 2003

(54) Environmentally-reactive seal and associated method

(75) Inventors: Abdullatif M. Chehab, Oviedo, FL (US); Jeffrey Richard Mallat, Winter Springs, FL (US); Charles A. Carlson JR., Chuluota, FL (US)

Correspondence Address: Siemens Corporation, Intellectual Property Department, 186 Wood Avenue South, Iselin, NJ, 08830, US

(73) Assignee: Siemens Westinghouse Power Corporation

(21) Appl. No.: 09/962,384

(22) Filed: Sep. 24, 2001

(51) Int. Cl. F16J 15/16

(52) U.S. Cl. 277/500

(57) ABSTRACT

An environmentally-reactive seal for reducing fluid flow within a region to be sealed which moves from an installation orientation to a blocking orientation in response to predetermined environmental conditions. The seal includes a deformable first portion that is sensitive to environmental conditions and a cooperative second portion. The first portion moves from a first orientation to a second orientation when certain predetermined environmental conditions are exhibited, thereby urging the second portion into a sealing arrangement with seating points in the region to be sealed. A method for sealing a region using an environmentally-reactive seal is also disclosed.

### FIELD OF THE INVENTION

This invention relates generally to the field of mechanical seals and, more particularly, to a two-part seal that automatically shifts from a compressed, installation or servicing orientation into an expanded, blocking orientation as anticipated environmental conditions are exhibited.

### BACKGROUND OF THE INVENTION

Complex industrial equipment is often comprised of many components, and fluids are commonly used with these components for a variety of purposes, including lubrication and the transfer of force. When used in this way, fluids help ensure that the equipment functions properly and prevent premature wear. Accordingly, it is important to reduce or eliminate the loss of these fluids, and seals are often used to address this concern.

In a typical sealing arrangement, the surfaces of adjacent components form a cavity or region through which fluid may leak if not checked by an appropriate seal. Commonly, the seal dimensions and the cavity dimensions are matched so that the seal contacts the cavity boundaries in a manner that reduces or prevents fluid leakage. Unfortunately, many types of equipment, including power-generating combustion turbines, generators and associated components, have parts that generate extreme temperatures or produce large amounts of contact-disrupting vibration during use. Additionally, many components are difficult to reach because they are in remote locations and difficult to reach. As a result, a variety of seals have been developed.

One sealing arrangement places an elastomeric member within the cavity formed between components to be sealed and forces together the components that form the cavity walls. As the components are forced together, increased contact between the elastomer and the components prevents fluids from passing therebetween. Although effective in some situations, this type of arrangement may not be acceptable in all cases, because the relatively-large of amounts of clamping force that may be required to maintain an effective seal can lead to high stresses and reduced part life.

Another sealing arrangement uses an expanding elastomer that is held in a compressed orientation during installation by a retaining member that is to be removed after the seal has been seated. After installation, the retaining member is removed, allowing the compressed elastomer to expand, thereby filling the space between the adjacent components and producing a seal therebetween. While this arrangement may be satisfactory for some settings, it can be dangerous; failure to remove the retaining member may cause the seal to malfunction. Additionally, even if the retention member is removed, difficulties encountered while removing the retaining member from remotely-located seals may cause the seal to become crimped or improperly seated, with both results producing diminished sealing capacity.

Metallic seals have also been developed, and these partially address some of the shortcomings of elastomeric seals. For example, metallic seals may be more temperature tolerant than elastomeric seals and may, therefore, be used to seal environments that experience very high and low temperatures. Although some metallic seals use retaining members, with the same liabilities mentioned above, others use materials that change shape in response to environmental conditions. These shape-changing metal seals are useful in some cases, but exhibit reduced effectiveness in many situations, including environments that require sealing of components that are rough-surfaced, disjointed, or prone to large amounts of vibration.

Metallic seals with soft coatings have also been developed. These seals may be useful in limited situations, but are poorly suited for many situations, including those that are characterized by large amounts of vibration or movement between rough component surfaces. In these situations, repeated motion at critical contact points can wear away at the seal coating and/or the components to be sealed, resulting in reduced sealing capacity. This wear may difficult to see and can, over time, lead to complete failure of the seal arrangement.

Accordingly, a need exists in the art for a sealing device that is capable of providing an effective seal in a variety of settings, including power generation equipment and other types of industrial machinery. The device should be tolerant of extreme temperatures and large amounts of vibrations, even in conjunction with components having disjointed or imperfect surfaces. The device should also be easy to install, even in remote locations, without requiring the removal of a retention member. Additionally, the device should be modular, so that the seal is customizable, easy to inspect and easy to repair.

### SUMMARY OF THE INVENTION

The instant invention is an environmentally-reactive seal that automatically moves between a first orientation, in which the seal may be easily installed and removed, and a second orientation, in which the assembly provides a fluid-tight seal between two or more components, in response to changes in environmental conditions, such as temperature or pressure. The seal includes a dynamic first portion which acts as a biasing element that selectively forces a second portion against the boundaries of a cavity to be sealed. The first portion is sensitive to environmental conditions and changes shape predictably as the environment surrounding the seal shifts between ambient and operational conditions. The first and second portions of the seal may each be selected independently according to the operating environment of the seal and may also be inspected and replaced independently, as well.

Accordingly, it is an object of the present invention to provide a seal particularly suited for dynamic environments that experience changes in temperature and/or pressure during operation.

It is another object of the present invention to provide a seal particularly suited for environments that experience temperature and pressure extremes during operation.

It is another object of the present invention to provide a seal particularly suited for environments that are disjointed, experience large amounts of vibration, or undergo physical changes.

It is yet a further object of the present invention to provide a seal that is easy to install and remove in remote locations.

It is also an object of the present invention to provide a seal that is modular, having components that are easy to repair and independently selectable.

Other objects and advantages of this invention will become apparent from the following description taken in conjunction with the accompanying drawings wherein are set forth, by way of illustration and example, certain embodiments of this invention. The drawings constitute part of this specification and include exemplary embodiments of the present invention and illustrate various objects and features thereof.

### BRIEF DESCRIPTION OF THE DRAWING

FIG. 1 is a partial perspective view of the seal of the present invention in use;

FIG. 2A is a partial close-up view of the seal shown in FIG. 1;

FIG. 2B is a side view of the view of the seal shown in FIG. 2A shown in a servicing orientation;

FIG. 2C is side view of the seal shown in FIG. 2A shown in a blocking orientation;

FIG. 3A is a partial close-up view of an alternate embodiment of the seal of the present invention;

FIG. 3B is a side view of the seal shown in FIG. 3A shown in a servicing orientation; servicing

FIG. 3C is side view of the seal shown in FIG. 3A shown in a blocking orientation;

FIG. 4A is a partial close-up view of an alternate embodiment of the seal of the present invention;

FIG. 4B is a side view of the seal shown in FIG. 4A shown in a servicing orientation;

FIG. 4C is side view of the seal shown in FIG. 4A shown in a blocking orientation;

FIG. 5A is a partial close-up view of an alternate embodiment of the seal of the present invention;

FIG. 5B is a side view of the view of the seal shown in FIG. 5A shown in a servicing orientation; and

FIG. 5C is side view of the seal shown in FIG. 5A shown in a blocking orientation.

### DETAILED DESCRIPTION OF THE INVENTION

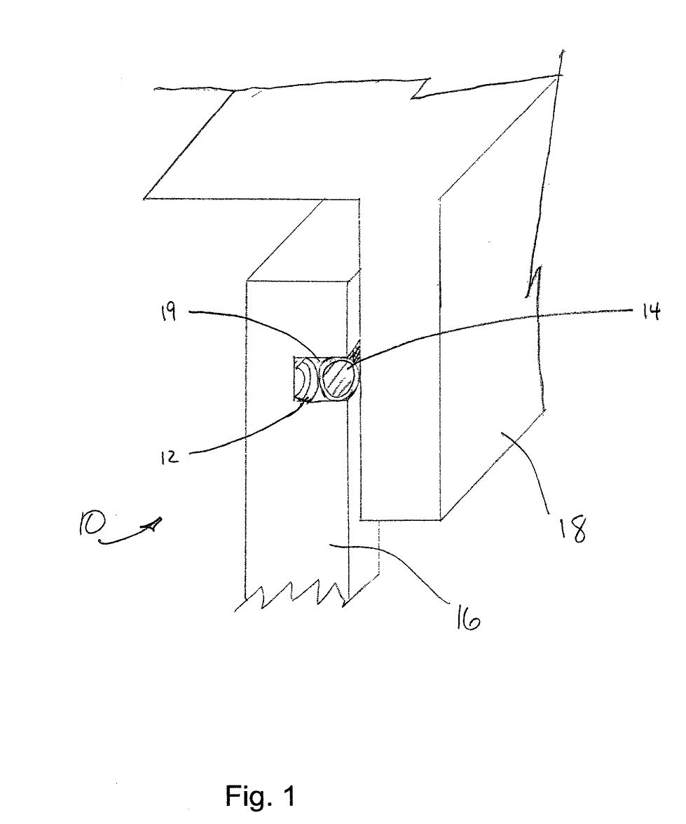

Reference is now made to in general to the Figures, wherein an environmentally-reactive seal 10 according to the present invention is shown. By way of overview, and with particular reference to FIG. 1, the seal 10 includes a first portion 12 that interacts with a second portion 14 to prevent or reduce fluid flow between adjacent components such as a seal housing 16 and a corresponding seal cap 18. Such an environment may be threaded and may be characterized by large amounts of vibration. The environment may also be characterized by disjointed surfaces. The seal 10 is placed with the cavity 19 formed by adjacent components to be sealed. The cavity 19 need not be formed by separate components 16,18; a suitable region to be sealed may also be formed by a single components. By employing multiple portions 12,14, the seal 10 of the present invention advantageously allows replacement of worn portions and allows custom combinations of either or both portions separately to match various components 16,18 and environments.

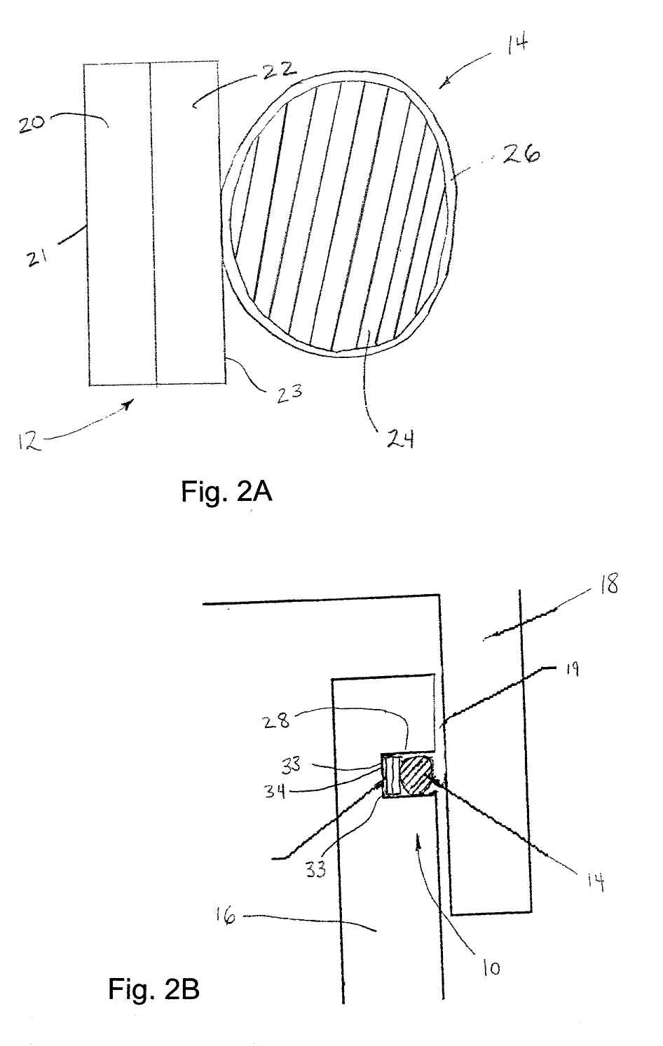

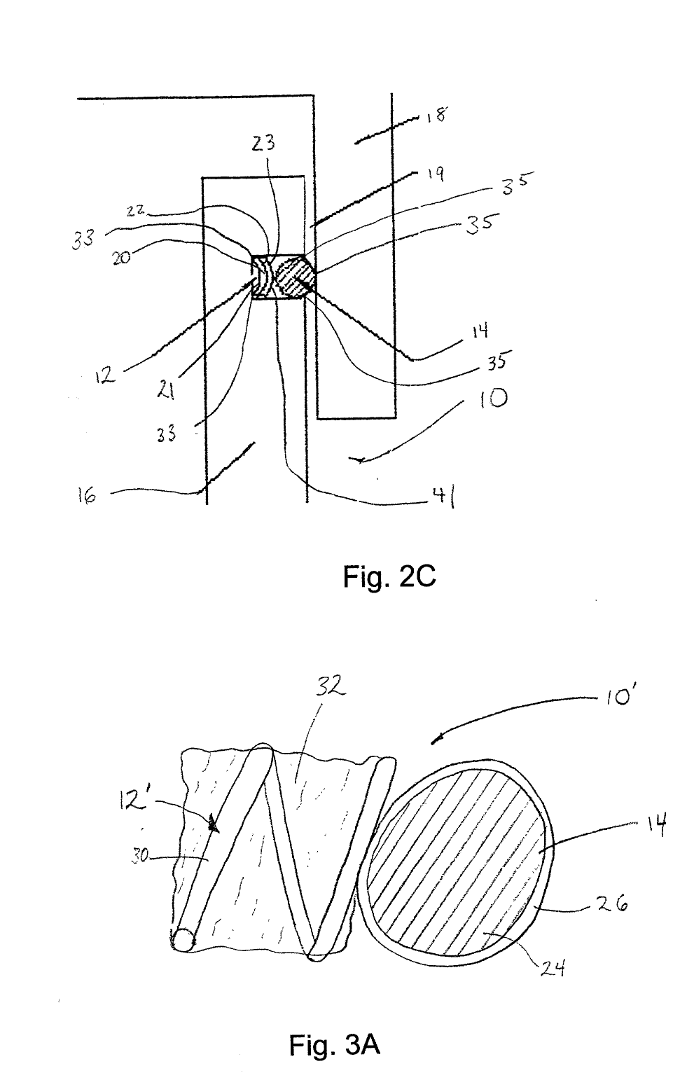

As will be described in further detail below, the seal 10 automatically moves between a first orientation and a second orientation, as the first portion 12 responds to environmental changes. In the first orientation, also referred to an as servicing orientation, the seal 10 has a compact arrangement suited for easy installation and removal. The first orientation is shown in FIGS. 2B, 3B, 4B, and 5B. In the second orientation, also referred to as a blocking orientation, the seal 10 occupies a comparatively-larger orientation which is well-suited for reducing or eliminating fluid flow between two or more selected components 16,18. The second orientation is shown in FIGS. 2C, 3C, 4C, and 5C.

With reference to FIG. 2A, one embodiment of the first portion 12 will now be described. In this embodiment, the first portion 12 is formed from two metallic pieces 20,22 permanently joined together to form a so-called “bimetallic strip.” The bimetallic strip 12 is a generally-elongated member comprised of two layers 20,22 of metal, with each layer preferably having a different coefficient of thermal expansion. With this arrangement, the strip 12 will have opposing surfaces 21,23 that will behave differently when subjected to changing temperatures, thereby advantageously bending the first portion 12 into a curved shape as the seal is exposed to increased temperature. The layers 20,22 may be congruent, but need not be; layers of different size may be used if desired. Typical dimensions for the bimetallic strip 12 will vary among applications, but in one embodiment, each layer 20,22 is about 0.06 inches thick, about 0.38 high and several inches long.

Materials suitable for the bimetal strip 12 include, for example, austensitic, martensitic, ferritic stainless steel pieces. Use of these materials will yield a bimetal strip 12 having high corrosion resistance and strength. Where these properties are not needed or desired, other materials may also be used, including nickel-based or iron-based superalloys or similar materials having elevated-temperature corrosion resistance. It should also be noted that differences in thermal expansion need not be produced through the use of different materials; any arrangement that produces different responses to heat on opposing surfaces 21,23 may be used. The first member 12 may also be formed from more than two strips if desired, and these strips need not be metal. Additionally, it is noted that materials selected for the first member 12 may be chosen to either promote or restrict movement of the first portion 12 from the second orientation back to the first orientation. Depending upon the dimensions of the region 19 to be sealed, the first portion 12 may be narrow or elongated as needed to support the second portion 14 and may be used in multiples. The first and second portions 12,14 may also be joined together before use by any suitable means, if desired.

With continued reference to FIG. 2A, the second portion 14 of the present invention will now be described. The second portion 14 preferably resembles a hose or other flexible tube and preferably has a filled inner core. More particularly, the second portion is a flexible, resiliently-deformable component having an inner core 24 substantially enclosed by an outer sheath 26. The inner core 24 is preferably a pliable ceramic rope or similarly-compressible structure. The ceramic rope makes the second portion 14 tolerant of extreme temperatures and disjointed surfaces, but other materials may be used as dictated by expected environmental conditions. For example, the second portion14 may also include an o-ring member, an elastomeric band or strip, or other deformable elements. Additionally, the second portion14 need not be a single piece element, nor need the second portion be resiliently compressible. The outer sheath 26 is similarly not necessary, but will increase the life span of the second portion14 and the ability of the seal 10 to resist damage from abrasion. The sheath 26 substantially surrounds the inner core 24 and is preferably formed from a braided or woven metallic material, such as nickel-based or cobalt-based superalloys. Other materials may also be chosen according to expected environmental conditions, including stainless steel alloys or polymers.

Now with reference to FIG. 2B, the first or servicing orientation of the seal 10 will be described. When the seal 10 is in the servicing orientation, the first portion 12 of the assembly has a generally-flat cross section. As noted above, the servicing orientation promotes installation and removal of the seal 10, and this flat cross section helps achieve this result.

In preparation for use, the seal 10 is placed, while in the first orientation, into a reception notch or channel 28 disposed in a seal housing 16, with the relatively-compact nature of the first orientation easing installation. The first portion 12 is placed against at least one bracing point 33 within a closed region 34 of the reception channel 28, and the second portion14 of the seal 10 is placed against the first portion. As will be described more fully below, the first portion 12 will automatically expand into a blocking orientation as the environment surrounding the seal approaches a target temperature. Therefore, the seal 10 may or may not extend out of the reception notch or channel 28 in the servicing orientation. While the exact size of the first portion 12 and second portionl4 is not critical, when the combined outer dimensions of these elements approximate the size of the reception channel 28, placement stability is increased. Additionally, the first portion 12 may be sandwiched between more than one second portion 14, and more than one second portion may be placed together, allowing for an easily-modifiable interface between the seal 10 and the region 19 to be sealed.

Now with particular reference to FIG. 2C, the second or blocking orientation of the seal 10 will be described. As the operating environment of the seal 10 approaches a predetermined target operating temperature, the assembly moves from the first, servicing orientation, to a second, blocking orientation. While the assembly 10 warms up, the different coefficients of thermal expansion present in the first portion 12 layers 20,22 cause the first portion to bend or bow in a predictable manner. As the temperature of the first portion 12 gets closer to the target temperature, the first portion bends into the blocking orientation shown in FIG. 2C. This bending causes the first member 12 to positively engage the second portion 14, along a first portion interface surface 41. As the first portion 12 moves into the second orientation, the first and second portions cooperatively engage the first and second components 16,18, along bracing and seating points 33,35, respectively, thereby entering a sealing relationship with the associated region and reducing or preventing fluid flow past the seating points.

It is to be noted that seal 10 will provide effective sealing through a range of temperatures, and that the target temperature will vary from application to application. However, one exemplary target temperature is about 750° F., and one exemplary range of effectiveness is from about 100° F. to 1000° F.

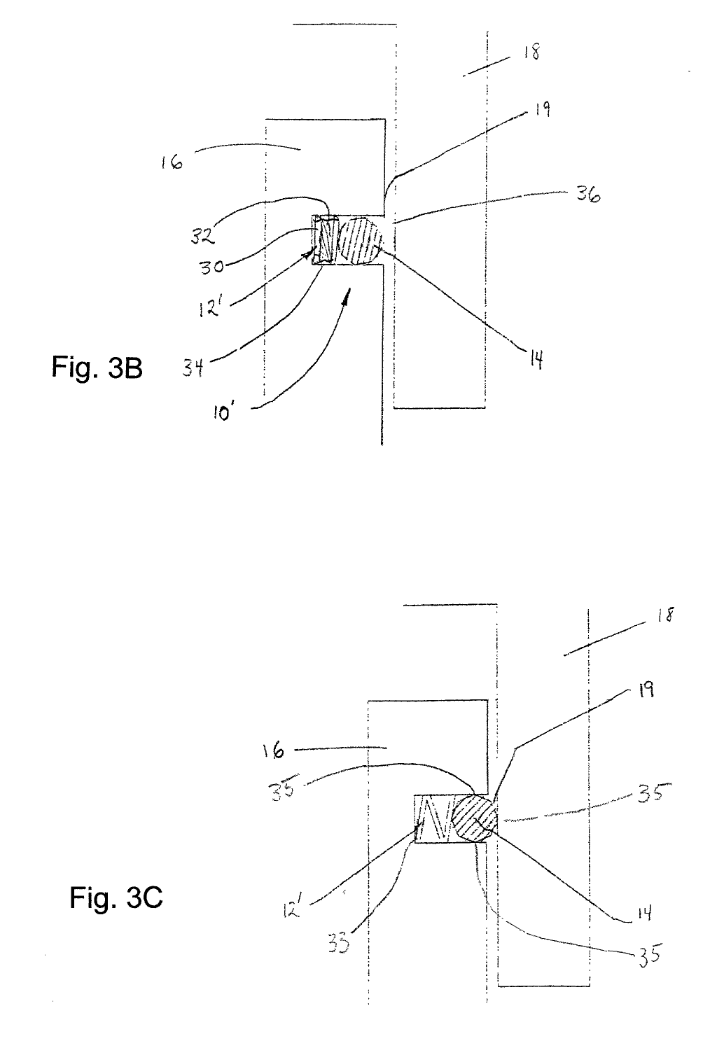

Now with reference to FIG. 3A, a second embodiment of the seal 10′ of the present invention will be described. This embodiment of the seal 10′ employs the second portion 14 described above in conjunction with an alternate first portion 12′. This second embodiment of the first portion 12′ includes a biasing member 30 and a retaining medium 32. The biasing member 30 is preferably a spring element, which may be a leaf spring, a coiled member or other similar resilient member, and the retention medium 32 is preferably wax, tape, or some other similarly heat-sensitive material. With this arrangement, the retention medium 32 will melt or otherwise disintegrate at operating conditions. The retention medium will As seen in FIG. 3B, when the seal 10 is in the servicing orientation, the first portion 12′ is held in a compressed state by the retention medium 32. Depending upon the dimensions of the region 19 to be sealed, the first portion 12′ may be narrow or elongated as needed to support the second portion 14 and may be used in multiples. The first and second portions 12′,14 may also be joined together before use by any suitable means, if desired.

The servicing orientation of a second embodiment of the seal 10′ will now be described, with reference to FIG. 3B. With this embodiment of the seal 10′, an alternate first portion 12′ cooperates with the previously-described second portion14. The first portion 12′ includes a biasing member 30, such as a spring, selectively held in a compressed first or servicing orientation by a retention medium 32, such as wax or tape. The retention medium 32 of this first portion 12′ need not be wax, but is preferably a material having a melting or disintegration temperature above ambient operating temperatures of the seal 10′ environment and below the operating or target temperature. With this arrangement, the first portion 12′ will remain in the servicing orientation while the seal 10′ is installed, but will expand as the seal environment approaches the target temperature. Although operating and target temperatures will vary between to different applications, in one exemplary situation, the ambient temperatures is about 70° F. and the target temperature is about 750° F., with the first portion 12′ beginning to activate around about 150° F. The spring constant of the biasing member 30 may be altered to match the environment in which the seal 10′ will be used. In this manner, the biasing member 30 may be selected to provide the appropriate amount of force when engaging the second portion 14. This type of matching allows effective sealing with second portions14 of various sizes and materials, within environments having differing pressures, temperatures, and other conditions. It is noted that the biasing member need not be a spring, any temperature-tolerant member that may be held selectively in a compressed state may be used.

With reference to FIG. 3C, the second, or blocking, orientation of the seal 10′ will now be described. As the target temperature is approached, the retention medium 32 softens sufficiently to allow the compressed biasing member 30 to overpower the holding power of the retention medium and expand toward equilibrium. This expansion causes the first portion 12′ to positively engage the second portion 14. As the first portion 12′ moves into the second orientation, the first and second portions cooperatively engage the first and second components 16,18, along bracing and seating points 33,35, respectively, thereby entering a sealing relationship with the associated region and reducing or preventing fluid flow past the seating points.

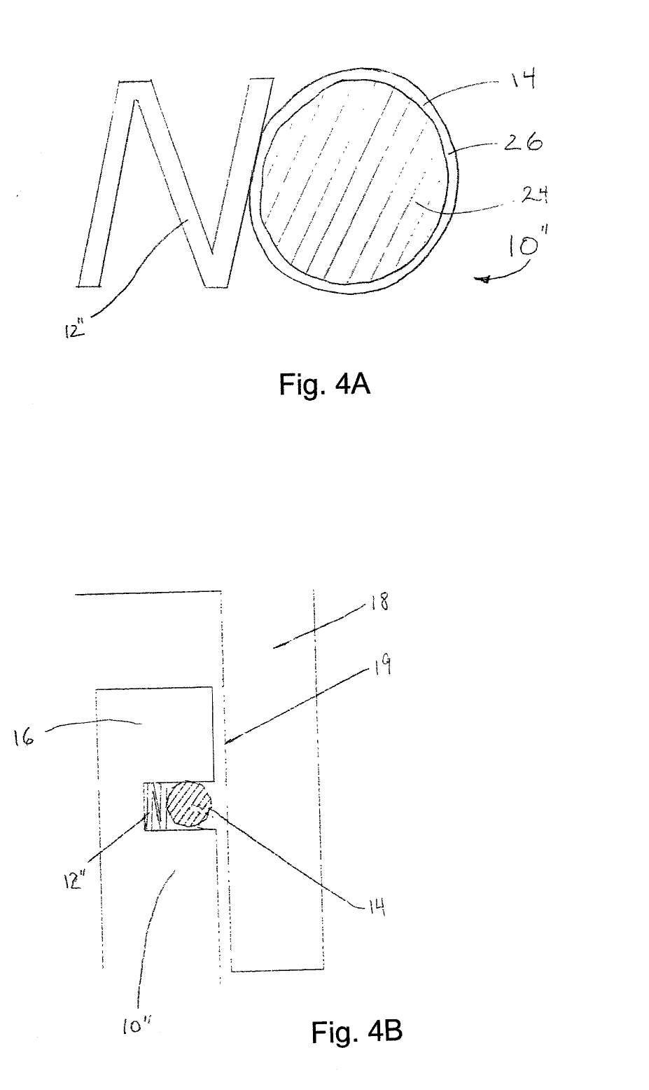

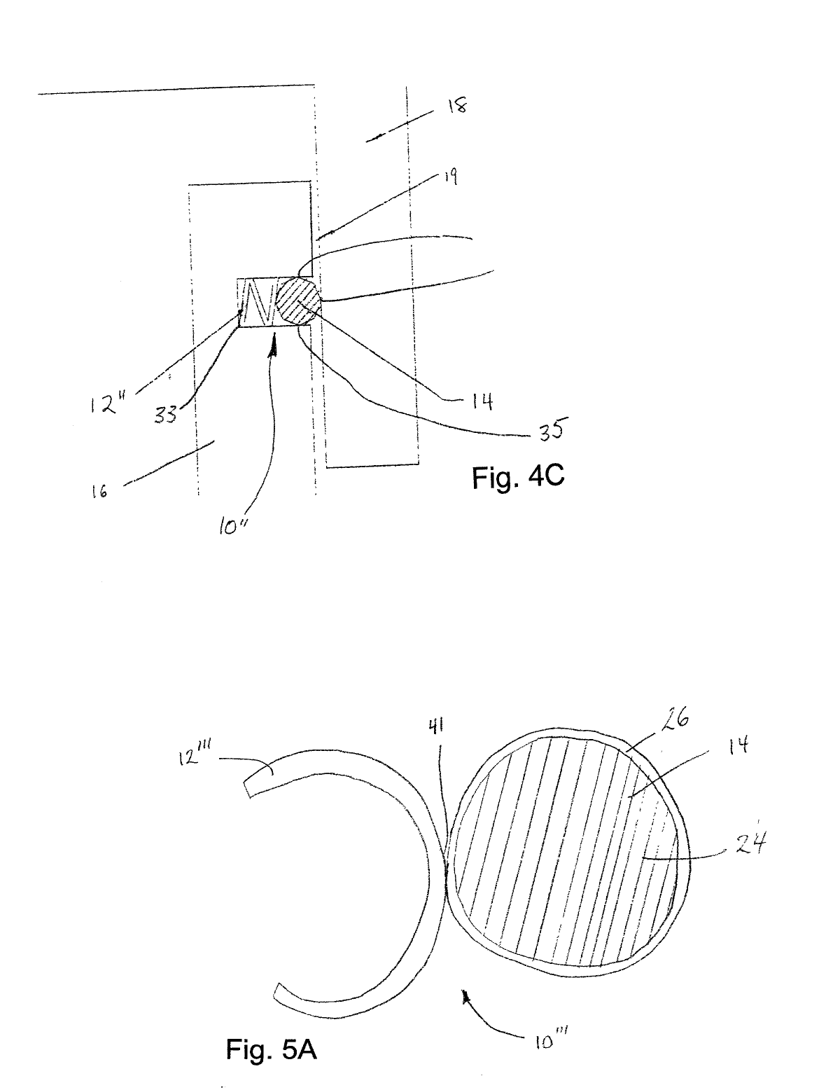

Now with reference to FIG. 4A, another embodiment of the seal 10″ of the present invention is shown. In this embodiment, the second portion14 discussed above is employed in conjunction with an alternate first portion 12″. The first portion 12″ is a component formed from a so-called shape memory alloys, such as a TiNi alloy, Cu-based alloys, or shape memory stainless steel (including FeMnSiCrNi, FeNiC, and FeMnSi), and which causes the first member to have a preset first shape at ambient conditions and a second preset shape at operating, target temperatures. The first and second shapes of the first portion 12″ are shown respectively in FIGS. 4B and 4C. As seen in the Figures, the first portion 12″ maintains a relatively-compact state at ambient conditions and a relatively-larger state when the operating environment of the seal 10″ approaches the target temperature.

During operation, as the environment surrounding the seal 10″ nears the target temperature, the seal adopts the blocking orientation shown in FIG. 4C. As this occurs, the first portion 12″ adopts the second shape and engages the second portion 14. As the first portion 12″ moves into the second orientation, the first and second portions cooperatively engage the first and second components 16,18, along bracing and seating points 33,35, respectively, thereby entering a sealing relationship with the associated region and reducing or preventing fluid flow past the seating points. It is to be noted that seal 10″ will provide effective sealing through a range of temperatures, and that the target temperature will vary from application to application. However, one exemplary target temperature is about 500° F., and one exemplary range of effectiveness is from about 300° F. to 500° F.

Although the first shape of the first member 12″ is shown as flat, other orientations may also be used, with the first shape being selected to ease installation and removal of the seal 10″. Therefore, the first preset shape, maintained by the first portion 12″ at ambient conditions, may have a variety of contours. The second preset shape, maintained as the target temperature is approached, will be different, at least in size. For example, one alternate first shape is a compact serpentine or “S” arrangement, not shown, with the corresponding second shape being an expanded serpentine shape. Other arrangements are possible, with the second shape having relatively-larger outer dimensions than the first shape. Additionally, depending upon the dimensions of the region 19 to be sealed, the first portion 12″ may be narrow or elongated as needed to support the seal second portion 14 and maybe used in multiples. The first and second portions 12″,14 may also be joined together before use by any suitable means, if desired.

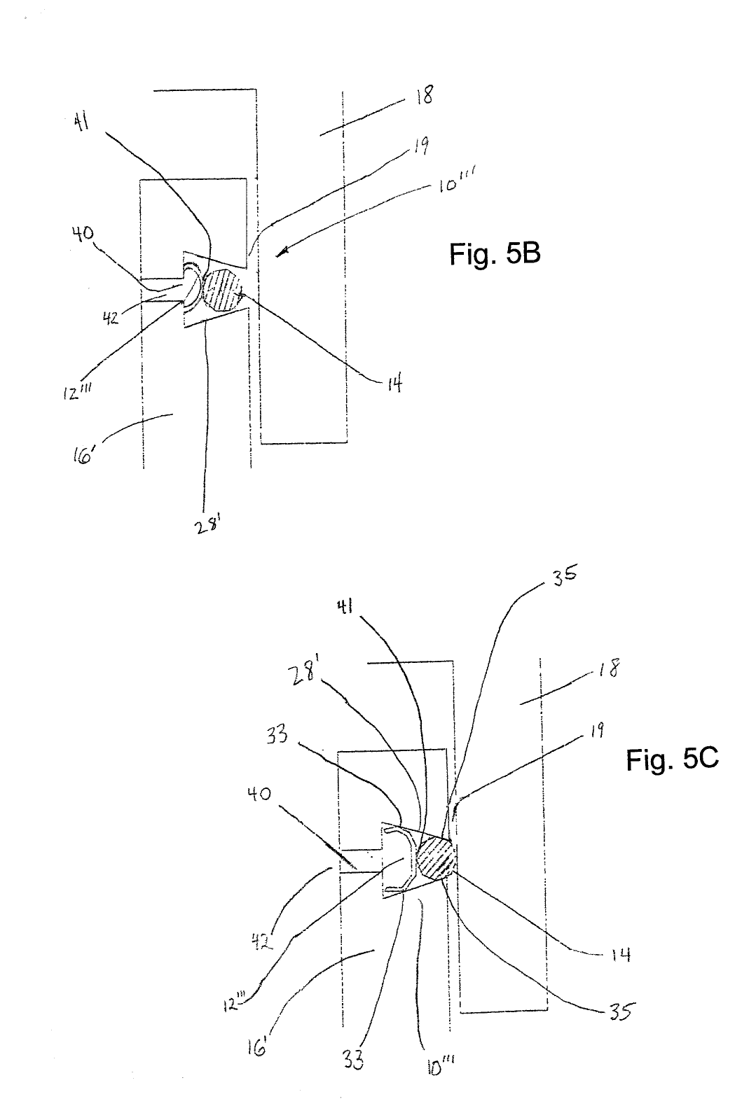

Now with reference to FIG. 5A, another embodiment of the seal 10′″ of the present invention is shown. The seal 10′″ of this embodiment is adapted for use with components 16′,18 whose environments experience changes in pressure during operation. In particular, the seal 10′″ may be used to stop fluid flow between two components 16′,18 where one of the components includes a pressure passthrough conduit 40 that directs pressure from a pressurized location 42 to the first portion 12′″ of the seal 10′″. In the embodiment shown, the first component 16′ includes a reception notch 28′ in fluid communication with the pressure passthrough conduit 40. The reception notch 28′ may have a variety of cross sections, in addition to the frusto-conical shape shown in FIG. 5A, including but not limited to, square and curved cross sections. Additionally, depending upon the dimensions of the region 19 to be sealed, the first portion 12′″ may be narrow or elongated as needed to support the second portion 14 and may be used in multiples. The first and second portions 12′″,14 may also be joined together before use by any suitable means, if desired.

With this arrangement, as seen with reference to FIGS. 5B and 5C, the first portion 12′″ effectively acts as a pressure barrier that deforms predictably during operation as increased pressure is transferred through the passthrough conduit 40. As the first portion 12′″ moves into the second orientation, it transfers the increased pressure to the second portion 14 along an interface surface 41. This causes the first and second portions 12′″,14 to cooperatively engage the first and second components 16,18, along bracing and seating points 33,35, respectively, thereby entering a sealing relationship with the associated region and reducing or preventing fluid flow past the seating points.

It is to be understood that while certain forms of the invention have been illustrated and described, it is not to be limited to the specific forms or arrangement of parts herein described and shown. It will be apparent to those skilled in the art that various, including modifications, rearrangements and substitutions, may be made without departing from the scope of this invention and the invention is not to be considered limited to what is shown in the drawings and described in the specification. The scope if the invention is defined by the claims appended hereto.

What is claimed is:

1. An environmentally-reactive seal for reducing fluid flow past a plurality of seating points disposed within a region to be sealed, said region having a boundary characterized by at least one bracing point, said seal comprising:
a first portion adapted to engage said at least one bracing point and adapted to automatically move from a first orientation to a second orientation in response to a preselected environmental condition; and
a deformable second portion adjacent said first portion, said second portion being adapted to adopt a sealing arrangement with said plurality of seating points when said first portion is in said second orientation, said second portion being urged into said sealing arrangement by said first portion,
whereby said seal is suited for installation and removal when said first portion is in said first orientation and suited for reducing fluid flow between said plurality of seating points when said first portion is in said second orientation.

2. The environmentally-reactive seal of claim 1, wherein said environmental condition is said first portion of said seal reaching a temperature of about at least 100° F.

3. The environmentally-reactive seal of claim 1, wherein said environmental condition is said first portion of said seal reaching a temperature within a predetermined range.

4. The environmentally-reactive seal of claim 3, wherein said predetermined range is from about 100° F. to 1000° F.

5. The environmentally-reactive seal of claim 2, wherein said first portion of said seal includes a deformable member adapted to maintain a first shape when said first portion is in said first orientation and to move into a second shape when said first portion is in said second orientation.

6. The environmentally-reactive seal of claim 5, wherein said deformable member includes an elongated element having a first surface opposed from a second surface, with said first and second surfaces each having a different coefficient of thermal expansion.

7. The environmentally-reactive seal of claim 5, wherein said deformable member includes an elongated element comprising a metal selected from the group consisting essentially of NiTi alloys, Cu-based alloys, and shape memory stainless steel.

8. The environmentally-reactive seal of claim 2, wherein said first portion of said seal includes a biasing member selectively retained in a compressed orientation by a retention component while said first portion is in said first orientation, said retention component being adapted to release said biasing member toward an equilibrium orientation in response to said preselected environmental condition.

9. The environmentally-reactive seal of claim 8, wherein said biasing member includes a spring.

10. The environmentally-reactive seal of claim 9, wherein said retention component includes wax having a melting temperature less than about 250° F.

11. An environmentally-reactive seal for reducing fluid flow past a plurality of seating points disposed within a region to be sealed, said region having a boundary characterized by at least one passthrough conduit, said seal comprising:
a first portion adapted for fluid communication with the at least one passthrough conduit and adapted to automatically move from a first orientation to a second orientation in response to a preselected environmental condition; and
a deformable second portion adjacent said first portion, said second portion being adapted to adopt a sealing arrangement with said plurality of seating points when said first portion is in said second orientation, said second portion being urged into said sealing arrangement by said first portion,
whereby said seal is suited for installation and removal when said first portion is in said first orientation and suited for reducing fluid flow between said plurality of seating points when said first portion is in said second orientation.

12. The environmentally-reactive seal of claim 1, wherein:
said first portion includes an interface surface in operational contact with said second portion; and
said environmental condition is a pressure differential between said interface surface and the passthrough conduit and said first portion sufficient to deflect said first portion into said second orientation.

13. The environmentally-reactive seal of claim 12, wherein said pressure differential is at least about 10 psi.

14. The environmentally-reactive seal of claim 12, wherein said pressure differential is within a predetermined range.

15. The environmentally-reactive seal of claim 3, wherein said predetermined range is from about 10 psi to 1000 psi.

16. A method of reducing fluid flow past a plurality of seating points disposed within a region to be sealed, said region having a boundary characterized by at least one bracing point, comprising:
forming an environmentally-reactive seal for reducing fluid flow past said plurality of seating points, said seal including a first portion adapted to engage said at least one bracing point and adapted to automatically move from a first orientation to a second orientation in response to a preselected environmental condition, and a deformable second portion adjacent said first portion, said second portion being adapted to adopt a sealing arrangement with said plurality of seating points when said first portion is in said second orientation, said second portion being urged into said sealing arrangement by said first portion;
placing said seal within said region to be sealed; and
subjecting said seal to said predetermined environmental condition.

17. The method of claim 16, wherein said environmental condition is said first portion of said seal reaching a temperature of about at least 100° F.

18. The method of claim 16, wherein said environmental condition is said first portion of said seal reaching a temperature within a predetermined range.

19. The method of claim 18, wherein said predetermined range is from about 100° F. to 1000° F.

20. The method of claim 17, wherein said first portion of said seal includes a deformable member adapted to maintain a first shape when said first portion is in said first orientation and to move into a second shape when said first portion is in said second orientation.
